(19) United States
(12) Patent Application Publication
(10) Pub. No.: US 2019/0356554 A1
(43) Pub. Date: Nov. 21, 2019

(54) TERMINAL APPLICATION CONTENT EVALUATING METHOD AND DEVICE

(71) Applicant: ZhongAn Information Technology Service Co., Ltd., Shenzhen (CN)

(72) Inventors: Chaoqun WANG, Shenzhen (CN); Di YING, Shenzhen (CN)

(21) Appl. No.: 16/458,351

(22) Filed: Jul. 1, 2019

Related U.S. Application Data
(63) Continuation of application No. PCT/CN2019/071302, filed on Jan. 11, 2019.

(30) Foreign Application Priority Data
May 16, 2018 (CN) 201810469185.9

(51) Int. Cl. H04L 12/24; G06F 16/22; H04L 29/08

(52) U.S. Cl. CPC H04L 41/142; G06F 16/2272; H04L 67/1097; H04L 67/22; H04L 67/306

(57) ABSTRACT

A terminal application content evaluating method includes: performing content configuration of multiple levels for a terminal application, and injecting an encoded value of content in the lowest level into a content attribute of the terminal application; collecting access data of the terminal application, the access data including a user identifier of an accessing user and an encoded value corresponding to the accessed content; storing the access data in a distributed message queue, and performing real-time calculation and analysis of the access data to obtain an analysis index of each level; evaluating the content of the terminal application according to the analysis index of each level.

### CROSS-REFERENCE TO RELATED APPLICATIONS

The application is a continuation of International Application No. PCT/CN2019/071302 filed on Jan. 11, 2019, which claims priority to the Chinese patent application No. 201810469185.9 filed on May 16, 2018. Both applications are incorporated herein by reference in there entireties.

### TECHNICAL FIELD

The disclosed embodiments relate to the technical field of network analysis, and specifically to a terminal application content evaluating method and device.

### BACKGROUND

As information technology and terminal applications develop rapidly, more and more various applications are installed on terminals. Contents of terminal applications, for example, goods information, advertisement promotion and so on displayed on pages of terminal applications, directly affect the experience of users accessing the terminal applications.

Therefore, evaluation of the content of the terminal applications attracts more and more concerns from developers and users.

At present, there is not yet a solution to how to perform accurate evaluation for the terminal application content and thereby provide a basis for more precisely performing optimized configuration for the terminal application content.

### SUMMARY

In view of the above, the embodiments of the present invention provide a terminal application content evaluating method and device, to perform accurate evaluation for the terminal application content and thereby provide a basis for more precisely performing optimized configuration for the terminal application content.

In a first aspect, a terminal application content evaluating method is provided. The method includes: performing content configuration of multiple levels for a terminal application, and injecting an encoded value of content in the lowest level into a content attribute of the terminal application; collecting access data of the terminal application, the access data including a user identifier of an accessing user and an encoded value corresponding to accessed content; storing the access data in a distributed message queue, and performing real-time calculation and analysis of the access data to obtain an analysis index of each level; evaluating the content of the terminal application according to the analysis index of each level.

In an embodiment, the multiple levels include a site level, a page level, a column level and an element level from top to bottom; the encoded value of content in the lowest level is obtained by four-level encoding according to a hierarchical relationship of the multiple levels.

In an embodiment, the injecting an encoded value of content in the lowest level into a content attribute of the terminal application includes: injecting the encoded value of the element level into the content attribute of the terminal application through a CMS system, the content attribute being an attr tag attribute obtained through base class configuration.

In an embodiment, the collecting access data of the terminal application includes: triggering, according to the accessing user's access operation on the terminal application, collection of the access data through an SDK code package pre-injected into the terminal application.

In an embodiment, the performing real-time calculation and analysis of the access data to obtain an analysis index of each level includes: obtaining the access data from the distributed message queue, and parsing the access data to obtain the user identifier and the encoded value corresponding to the accessed content; performing a statistic and a analysis of click data in the site level, page level, column level and element level respectively according to the user identifier and the encoded value corresponding to the accessed content.

In an embodiment, the access data further includes a terminal IP address, and the performing real-time calculation and analysis of the access data to obtain an analysis index of each level includes: determining a geographic area corresponding to the terminal IP address; and performing a statistic and a analysis of click data, according to the user identifier, the encoded value corresponding to the accessed content and the geographic area corresponding to the terminal IP address, in the site level, page level, column level, and element level for different geographic areas.

In an embodiment, the click data includes at least one of click times, the number of click users and a click-exit rate.

In a second aspect, a terminal application content evaluating device is provided. The device includes: a configuration module adapted to perform content configuration of multiple levels for a terminal application, and inject an encoded value of content in the lowest level into a content attribute of the terminal application; a collection module adapted to collect access data of the terminal application, the access data including a user identifier of an accessing user and an encoded value corresponding to the accessed content; a storage module adapted to store the access data in a distributed message queue; an analysis module adapted to perform real-time calculation and analysis of the access data to obtain an analysis index of each level; an evaluation module adapted to evaluate the content of the terminal application according to the analysis index of each level.

In an embodiment, the multiple levels include a site level, a page level, a column level and an element level from top to bottom; the encoded value of content in the lowest level is obtained by four-level encoding according to a hierarchical relationship of the multiple levels.

In an embodiment, the configuration module is specifically adapted to, after performing the content configuration of multiple levels for the terminal application, inject the encoded value of the element level into the content attribute of the terminal application through a CMS system, the content attribute being an attr tag attribute obtained through base class configuration.

In an embodiment, the collection module is specifically adapted to trigger, according to the accessing user's access operation on the terminal application, collection of the access data through an SDK code package pre-injected into the terminal application.

In an embodiment, the analysis module is specifically adapted to: obtain the access data from the distributed message queue, and parse the access data to obtain the user identifier and the encoded value corresponding to the accessed content; perform a statistic and a analysis of click data in the site level, page level, column level and element level respectively according to the user identifier and the encoded value corresponding to the accessed content.

In an embodiment, the access data further includes a terminal IP address, and the analysis module is specifically adapted to: determine a geographic area corresponding to the terminal IP address; perform a statistic and a analysis of click data, according to the user identifier, the encoded value corresponding to the accessed content and the geographic area corresponding to the terminal IP address, in the site level, page level, column level, and element level for different geographic areas.

In an embodiment, the click data includes at least one of click times, the number of click users and a click-exit rate.

The terminal application content evaluating method and device provided by the embodiments of the present invention have the following technical effects:

1. The effect analysis of the terminal application content is solved, and thereby providing a basis for more precisely performing operation and optimized configuration of the terminal application content;

2. The terminal application realizes module refinement by performing uniform encoding for the terminal application content, and data analysis and mining at different levels is further achieved;

3. A unified general-purpose operating scheme of full-link and automation is provided, which includes background configuration, foreground user triggering, real-time information calculation, effect analysis, operation policy adjustment, and so on;

4. the development for the terminal application is transparent without needing intervention of terminal application developers, and meanwhile the impact of monitoring work on business content development can be reduced;

5. The training cost of data used by operators is reduced, and adjustment of content and strategy of operation activities is quickly and timely.

### BRIEF DESCRIPTION OF DRAWINGS

To describe technical solutions of embodiments of the present invention more clearly, figures to be used in the embodiments will be described briefly. Obviously, the figures described below are only some embodiments of the present invention. Those having ordinary skill in the art appreciate that other figures may be obtained from these figures without making inventive efforts.

FIG. 1 is a flow chart of a terminal application content evaluating method according to an embodiment of the present invention.

FIG. 2 is a systematic flow chart for performing the evaluating method shown in FIG. 1 according to an embodiment of the present invention.

FIG. 3 is a structural schematic diagram of a terminal application content evaluating device according to an embodiment of the present invention.

### DETAILED DESCRIPTION

To make objectives, technical solutions and advantages of embodiments of the present invention clearer, technical solutions of embodiments of the present invention will be described clearly and completely with reference to figures in embodiments of the present invention. Obviously, embodiments described here are partial embodiments of the present invention, not all embodiments. All other embodiments obtained by those having ordinary skill in the art based on the embodiments of the present invention, without making any inventive efforts, fall within the protection scope of the present invention.

Embodiments of the present invention provide a terminal application content evaluating method and device. The method can be used to evaluate content of various applications on a terminal. A subject for performing the method can be a server which may be, via a network, communicatively connected with a plurality of terminals installed with terminal applications. The server may be a single physical server or a server cluster consisting of a plurality of physical servers. And in the server cluster, the plurality of physical servers is communicatively connected. The terminal may be an electronic device such as a mobile phone, a notebook computer, a desktop computer, a tablet computer or a smart TV set. It needs to be noted that a plurality of terminals installed with the same terminal application may be the same terminals, or different terminals. This is not limited in embodiments of the present invention.

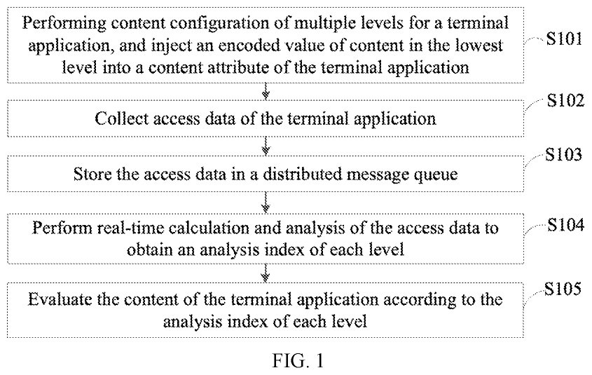

FIG. 1 shows a terminal application content evaluating method according to an embodiment of the present invention. Referring to FIG. 1, the terminal application content evaluating method includes the following steps:

101: performing content configuration of multiple levels for a terminal application, and injecting an encoded value of content in the lowest level into a content attribute of the terminal application.

The multiple levels include a site level, a page level, a column level and an element level from top to bottom. Specifically, a terminal application of the terminal corresponds to a site, and a terminal application may be adapted with at least one page; each page includes a plurality of columns having different data content, and a column may include a plurality of elements. For example, columns included in a page may be textual content, such as textual description about the subject matter of the webpage, or may be a link address for advertising promotion, displayed banners, video playing units and so on; the element may be a button or a button in a video playing unit.

In an embodiment, the process of performing content configuration of multiple levels for a terminal application includes: obtaining a content configuration request generated based on the user's operation of starting the terminal application; determining configuration information corresponding to the terminal application, according to the content configuration request; configuring the sites, pages, columns and elements in the configuration information to the site level, page level, column level and element level of the terminal application respectively.

For example, in this embodiment, when the user opens a terminal application on the terminal, the terminal application sends a content configuration request to the server to acquire content for configuring the terminal application. And the server returns business information via a Content Management System (CMS), where the business information includes configuration information respectively corresponding to the page, the column, and the element in the terminal application. Then the content of the terminal application is configured according to the configuration information.

The element is the content in the lowest level, and the encoded value of the element is obtained by four-level encoding according to the hierarchical relationship of the multiple levels. In this embodiment, the encoded value of the element is obtained by the four-level encoding according to the hierarchical relationship of the multiple levels, and the encoded value of the element and its corresponding site, page, column and element are correspondingly stored in a cms configuration table in the CMS system. The four-level encoding includes site encoding, page encoding, column encoding, and element encoding. Where a digital self-incremental sequence is used to uniquely encode the site to obtain a site code, the digital self-incremental sequence is used to uniquely encode the page to obtain a page code, letters are mixed with numbers to uniquely code the column to obtain a column code, and the element is uniquely encoded by employing random value generation manner. The column, page and site where the element lies can be solely determined through the encoded value of the element. Exemplarily, the encoded value of the element obtained by the four-level encoding is 3.10.Ed8f.49023. The specific encoding manner is not limited in embodiments of the present invention.

Specifically, the process of injecting the encoded value of the content in the lowest level into the content attribute of the terminal application may include that the server injects the encoded value of the element into the content attribute of the terminal application through the CMS system. The content attribute of the terminal application may be an attr tag attribute obtained by the terminal application through base class configuration.

102: collecting access data of the terminal application.

In this embodiment, the access data includes a user identifier of the accessing user and an encoded value corresponding to accessed content. The user identifier may be a terminal identifier of the user terminal, or may be the user's application account on the terminal application, including but not limited to application accounts such as the user's mobile phone number, QQ number, and Web Chat number. The encoded value corresponding to the accessed content mentioned here refers to the encoded value of the content in the lowest level corresponding to the content accessed by the user, for example, the encoded value of the content in the element level. Since the column, the page and the site where the element lies may be solely determined according to the encoded value of the content in the element level, it is possible to subsequently perform index analysis for the site level, the page level, the column level and the element level respectively according to the encoded value of the content in the element level. Thereby an effect of performing data analysis and mining for different levels according to the encoded value of the content in the lowest level is achieved.

Specifically, the process of collecting access data of the terminal application may include: triggering, according to the accessing user's access operation on the terminal application, collection of the access data through an SDK code package pre-injected into the terminal application. The access operation on the terminal application is performed by different accessing users on their respective terminals. For example, the access operation may be a click operation on a button of a banner displayed in a certain column of a certain page of the terminal application. The specific access operation is not limited in embodiments of the present invention.

In the embodiments of the present invention, the SDK code is pre-injected into the terminal application, so that when the user browses the terminal application, collection of data that the user accessed in the terminal application is triggered. In the present invention, relevant information is collected through code injection, which is different from a manual event tracking collection scheme in the prior art. The manual event tracking collection needs to develop a monitoring code for each element of the terminal application. However, in the present invention, after a seamless collection code package is accessed during the development process of the terminal application, it is only necessary to additionally configure the content attribute of the terminal application in the development, information collection is automatically implemented by the code package without developers' intervention, and thereby tedious operations of manual event tracking monitoring is avoided, so that the cost of collecting access data becomes lower and the access data can be collected more fully.

103: storing the access data in a distributed message queue.

Specifically, the access data is stored in a Kafka message queue.

Kafka is a high-throughput distributed message-publishing and subscribing system that may process streaming data of all actions in a consumer-scale website. Kafka is fast, scalable, distributed, partitioned and replicable submission log service.

104: performing real-time calculation and analysis of the access data to obtain an analysis index of each level.

Specifically, a storm real-time computing system is used to connect the Kafka message queue to obtain the access data in the Kafka message queue, and parse the access data to obtain related content, and the related content is performed a statistic and a analysis to complete the real-time computing task.

In some embodiments, a process of implementing step 104 may specifically include: obtaining the access data from the distributed message queue, and parsing the access data to obtain the user identifier and the encoded value corresponding to the accessed content; performing a statistic and a analysis of click data, according to the user identifier and the encoded value corresponding to the accessed content, in the site level, the page level, the column level and the element level respectively.

The click data includes at least one of click times, the number of click users and a click-exit rate. The click-exit rate is equal to a ratio of the number of exit users to the number of click users. The exit users refer to users who exit the terminal application after clicking the element.

Specifically, the statistic and the analysis of click data in the site level, the page level, the column level and the element level respectively according to the user identifier and the encoded value corresponding to the accessed content may include: the server obtains information at four levels, including site, page, column and element, corresponding to the encoded value of the element by looking up a cms configuration table stored in the CMS system, and using a storm computing framework to calculate click times, the number of click users and the click-exit rate at the above four levels in real time.

Exemplarily, illustration is presented by taking an example in which the click times is taken as an analysis index. It is possible to, through the above process, obtain the click times of a certain banner in the element level, the click times of a certain column in the column level, the click times of a certain page of the page level, and the click times of a certain terminal application of the site level.

In some embodiments, the access data further includes a terminal IP address, and the process of implementing step 104 further includes: determining a geographic area corresponding to the terminal IP address; performing a statistic and a analysis of click data, according to the user identifier, the encoded value corresponding to the accessed content and the geographic area corresponding to the terminal IP address, in the site level, the page level, the column level, and the element level for different geographic areas.

The click data includes at least one of click times, the number of click users and a click-exit rate. The click-exit rate is equal to a ratio of the number of exit users to the number of click users. The exit users refer to users who exit the terminal application after clicking the element.

In this embodiment, a province or city where the user lies when he accesses the terminal application can be obtained by parsing the terminal IP address, so that click data in the site level, the page level, the column level and the element level for different geographic areas can be performed the statistic and the analysis. For example, it is possible to make statistics of click times of users in Guangdong Province clicking a certain page at the page level of a certain terminal application.

105: evaluating the content of the terminal application according to the analysis index of each level.

Specifically, the click times, the number of click users and the click-exit rate of each level are respectively compared with a preset click times threshold, a threshold of the number of click users and a threshold of the click-exit rate, and whether the content of each level of the terminal application is reasonably adapted is evaluated according to the comparison result.

In addition, it is also possible to, by comparing the click times, the number of click users and the click-exit rate of each level of the terminal application, evaluate differences of different columns on the same page, differences of different elements in the same column, and differences of data on the same type of pages.

Furthermore, the method provided by the embodiments of the present invention may further include: adaptively adjusting a content configuration corresponding to the terminal application according to the evaluation result of the content of the terminal application.

Thus, it is possible to, by evaluating the content of the terminal application, perform content substitution for unreasonable content through the CMS configuration system. In addition, it is further possible to obtain demands with respect to new product recommendation and user marketing, and perform promotion of new content on the page and column with a high user activity, to obtain a desired effect.

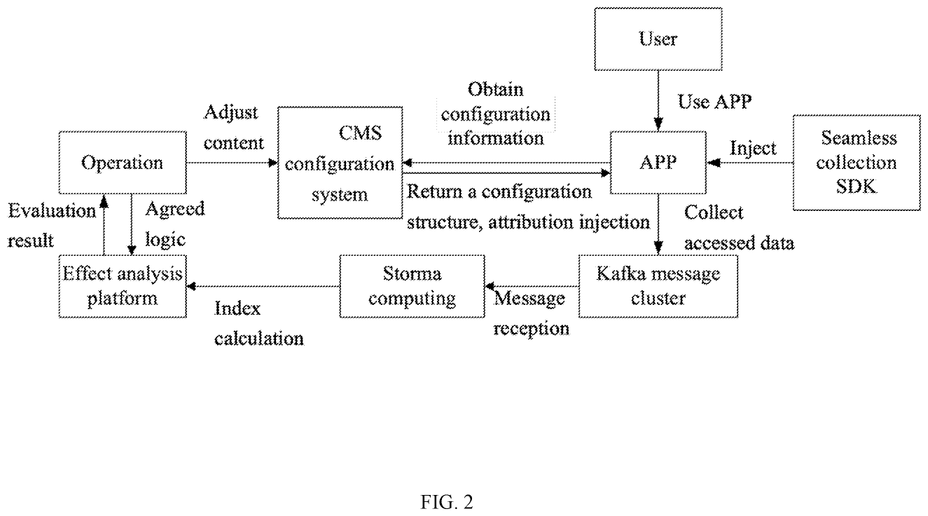

The process of executing the evaluation method shown in FIG. 1 will be described below with a specific embodiment with reference to FIG. 2. FIG. 2 is a systematic flow chart for performing the evaluating method shown in FIG. 1 according to an embodiment of the present invention. As shown in FIG. 2, after a user opens a terminal application APP in the terminal, the APP sends the server a request to obtain configuration information. The server returns a result matched with the request through the CMS system. Then content configuration for the site level, the page level, the column level and the element level of the APP is performed according to the result, and the encoded value of the content of the element level is injected into the attr tag attribute of the element of the APP. Then, when the user browses the APP, the SDK code pre-injected into the APP is triggered, the access data in the APP by the server is seamless collected. The collected access data includes the attr tag attribute, i.e., the collected access data includes the encoded value of the content of the element level corresponding to the content accessed by the user. Then, the server sends the collected access data to the Kafka message queue; the storm real-time computing system is connected to the Kafka message queue, to obtain the access data from the Kafka message queue, and perform analysis index calculation according to an agreed logic, for example, calculates the click times within a predetermined time period. Finally, evaluation of the content in the APP is performed based on the analysis index of each level. This lays the foundation for the adjustment and optimization of APP content.

The embodiment of the present invention provides a terminal application content evaluating method. According to the method, firstly, the content configuration of multiple levels for a terminal application is performed, and an encoded value of content in the lowest level is injected into the content attribute of the terminal application; the access data of the terminal application is collected, the access data includes a user identifier of the accessing user and an encoded value corresponding to the accessed content; then the access data is stored in a distributed message queue, and the analysis index of each level is obtained by real-time calculating and analyzing of the access data; and finally the content of the terminal application is evaluated according to the analysis index of each level. In this way, according to the method provided by the present invention, it is possible to perform effect analysis for the terminal application content and thereby provide a basis for more precisely performing operation and optimized configuration of the terminal application content; meanwhile it is possible to, by performing uniform encoding for the terminal application content, implement the terminal application overall module refinement of the terminal, achieve the effect of performing data analysis and mining at different levels, and provide a unified general-purpose full-link, automated operation scheme including background configuration, foreground user triggering, real-time information calculation, effect analysis, operation policy adjustment, and so on; the development for the terminal application is transparent without needing intervention of terminal application developers, and meanwhile it is also possible to reduce the impact of monitoring work on business content development, and reduce the learning cost of operating personnel using data, so as to quickly and timely adjust operation activity content and activity policies.

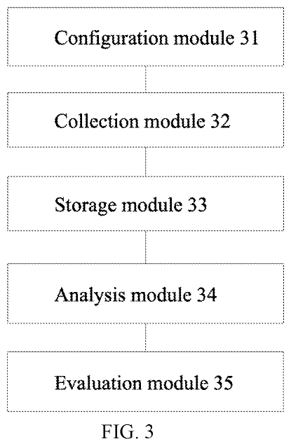

FIG. 3 shows a terminal application content evaluating device according to an embodiment of the present invention. The device is, through a network, communicatively connected to a plurality of terminals installed with a terminal application. Referring to FIG. 3, the evaluating device includes: a configuration module 31 adapted to perform content configuration of multiple levels for a terminal application, and inject an encoded value of content in the lowest level into a content attribute of the terminal application; a collection module 32 adapted to collect access data of the terminal application, the access data including a user identifier of the accessing user and an encoded value corresponding to the accessed content; a storage module 33 adapted to store the access data in a distributed message queue; a analysis module 34 adapted to perform real-time calculation and analysis of the access data to obtain an analysis index of each level; and an evaluation module 35 adapted to evaluate the content of the terminal application according to the analysis index of each level.

In some embodiments, the multiple levels include a site level, a page level, a column level and an element level from top to bottom.

The encoded value of content in the lowest level is obtained by the four-level encoding according to a hierarchical relationship of the multiple levels.

In some embodiments, the collection module 32 is specifically adapted to: trigger, according to the accessing user's access operation on the terminal application, collection of the access data through an SDK code package pre-injected into the terminal application.

In some embodiments, the analysis module 34 is specifically adapted to: obtain the access data from the distributed message queue, and parse the access data to obtain the user identifier and the encoded value corresponding to the accessed content; perform a statistic and a analysis of click data in the site level, page level, column level and element level respectively according to the user identifier and the encoded value corresponding to the accessed content.

In some embodiments, the access data further includes a terminal IP address, and the analysis module 34 is specifically adapted to: determine a geographic area corresponding to the terminal IP address; perform a statistic and a analysis of click data, according to the user identifier, the encoded value corresponding to the accessed content and the geographic area corresponding to the terminal IP address, in the site level, page level, column level, and element level for different geographic areas.

In some embodiments, the click data includes at least one of click times, the number of click users and a click-exit rate.

The embodiment of the present invention provides a terminal application content evaluating device. The device performs effect analysis for the terminal application content and provides a basis for more precisely performing operation and optimized configuration of the terminal application content; meanwhile it is possible to, by performing uniform encoding for the terminal application content, implement the terminal application overall module refinement of the terminal, achieve the effect of performing data analysis and mining at different levels, and provide a unified general-purpose full-link, automated operation scheme including background configuration, foreground user triggering, real-time information calculation, effect analysis, operation policy adjustment, and so on; in addition, the development for the terminal application is transparent without needing intervention of terminal application developers, and meanwhile it is also possible to reduce the impact of monitoring work on business content development, and reduce the learning cost of operating personnel using data, so as to quickly and timely adjust operation activity content and activity policies.

All of the above optional technical solutions may be used in any combination to form optional embodiments of the present invention, which will not be described in detail one by one.

It needs to be appreciated that the terminal application content evaluating apparatus provided by the above embodiment, upon performing the terminal application content evaluating method, is illustrated exemplarily only with the division of the above function modules. In practical application, it is possible to allocate the above functions to be completed by different function modules according to needs, namely, divide the internal structure of the apparatus into different function modules to accomplish all or part of the above-described functions. In addition, the above terminal application content evaluating method and terminal application content evaluating apparatus belong to the same concept, and their specific implementation process may be found in the method embodiment and will not be detailed any more here.

In an embodiment, the terminal application content evaluating device includes a processor, and a memory for storing instructions executable by the processor, wherein the processor is configured to performing the terminal application content evaluating method provided in any of the above embodiments.

Those having ordinary skill in the art may appreciate that all or part of the steps of implementing the above embodiments may be completed by hardware, or may be completed by relevant hardware instructed by a program. The program may be stored in a computer readable storage medium. The above-mentioned storage medium may be a read only memory, a magnetic disk, an optical disk or the like.

What are described above are only preferred embodiments of the present invention and are not intended to limit the present invention. Any modifications, equivalent substitutions, improvements, etc. made within the spirit and scope of the present invention are intended to be included in the scope of the present invention.

What is claimed is:

1. A terminal application content evaluating method, comprising:
performing content configuration of multiple levels for a terminal application, and injecting an encoded value of content in the lowest level into a content attribute of the terminal application;
collecting access data of the terminal application, the access data comprising a user identifier of an accessing user and an encoded value corresponding to accessed content;
storing the access data in a distributed message queue, and performing real-time calculation and analysis of the access data to obtain an analysis index of each level;
evaluating the content of the terminal application according to the analysis index of each level.

2. The terminal application content evaluating method of claim 1, wherein the multiple levels comprise a site level, a page level, a column level and an element level, from top to bottom;
the encoded value of content in the lowest level is obtained by four-level encoding according to a hierarchical relationship of the multiple levels.

3. The terminal application content evaluating method of claim 2, wherein the injecting an encoded value of content in the lowest level into a content attribute of the terminal application comprises:
injecting the encoded value of the element level into the content attribute of the terminal application through a CMS system, the content attribute being an attr tag attribute obtained through base class configuration.

4. The terminal application content evaluating method of claim 1, wherein the collecting access data of the terminal application comprises:
triggering, according to the accessing user's access operation on the terminal application, collection of the access data through an SDK code package pre-injected into the terminal application.

5. The terminal application content evaluating method of claim 2, wherein the performing real-time calculation and analysis of the access data to obtain an analysis index of each level comprises:
obtaining the access data from the distributed message queue, and parsing the access data to obtain the user identifier and the encoded value corresponding to the accessed content;
performing a statistic and a analysis of click data in the site level, the page level, the column level and the element level respectively according to the user identifier and the encoded value corresponding to the accessed content.

6. The terminal application content evaluating method of claim 2, wherein the access data further comprises a terminal IP address, and the performing real-time calculation and analysis of the access data to obtain an analysis index of each level comprises:
determining a geographic area corresponding to the terminal IP address;
performing a statistic and a analysis of click data, according to the user identifier, the encoded value corresponding to the accessed content and the geographic area corresponding to the terminal IP address, in the site level, the page level, the column level, and the element level for different geographic areas.

7. The terminal application content evaluating method of claim 5, wherein the click data comprises at least one of click times, the number of click users and a click-exit rate.

8. A terminal application content evaluating device, comprising a memory and a processor, wherein the processor executes the following steps:
performing content configuration of multiple levels for a terminal application, and injecting an encoded value of content in the lowest level into a content attribute of the terminal application;
collecting access data of the terminal application, the access data comprising a user identifier of an accessing user and an encoded value corresponding to the accessed content;
storing the access data in a distributed message queue;
performing real-time calculation and analysis of the access data to obtain an analysis index of each level;
evaluating the content of the terminal application according to the analysis index of each level.

9. The terminal application content evaluating device of claim 8, wherein the multiple levels comprise a site level, a page level, a column level and an element level from top to bottom;
the encoded value of content in the lowest level is obtained by four-level encoding according to a hierarchical relationship of the multiple levels.

10. The terminal application content evaluating device of claim 9, wherein when executing the step of injecting an encoded value of content in the lowest level into a content attribute of the terminal application, the processor specifically executes the following steps:
injecting the encoded value of the element level into the content attribute of the terminal application through a CMS system, the content attribute being an attr tag attribute obtained through base class configuration.

11. The terminal application content evaluating device of claim 8, wherein when executing the step of collecting access data of the terminal application, the processor specifically executes the following steps:
triggering, according to the accessing user's access operation on the terminal application, collection of the access data through an SDK code package pre-injected into the terminal application.

12. The terminal application content evaluating device of claim 9, when executing the step of performing real-time calculation and analysis of the access data to obtain an analysis index of each level, the processor specifically executes the following steps:
obtaining the access data from the distributed message queue, and parsing the access data to obtain the user identifier and the encoded value corresponding to the accessed content;
performing a statistic and a analysis of click data in the site level, page level, column level and element level respectively according to the user identifier and the encoded value corresponding to the accessed content.

13. The terminal application content evaluating device of claim 9, wherein the access data further comprises a terminal IP address, and when executing the step of performing real-time calculation and analysis of the access data to obtain an analysis index of each level, the processor specifically executes the following steps:
determining a geographic area corresponding to the terminal IP address;
performing a statistic and a analysis of click data, according to the user identifier, the encoded value corresponding to the accessed content and the geographic area corresponding to the terminal IP address, in the site level, page level, column level, and element level for different geographic areas.

14. The terminal application content evaluating device of claim 12, wherein the click data comprises at least one of click times, the number of click users and a click-exit rate.
